(19) United States
(12) Patent Application Publication
(10) Pub. No.: US 2022/0034673 A1
(43) Pub. Date: Feb. 3, 2022

(54) TRAILER-CONSIDERATE ROUTE RECOMMENDATIONS

(71) Applicant: GM Global Technology Operations LLC, Detroit, MI (US)

(72) Inventors: Donald K. Grimm, Utica, MI (US); Fan Bai, Ann Arbor, MI (US); David E. Bojanowski, Clarkston, MI (US); Brooke A. Hart, Beverly Hills, MI (US); Jeffrey M. Evangelist, Grosse Pointe Park, MI (US)

(21) Appl. No.: 16/983,505

(22) Filed: Aug. 3, 2020

(51) Int. Cl. G01C 21/34; G01C 21/36; G06N 20/00

(52) U.S. Cl. CPC G01C 21/3484; G01C 21/3407; G06N 20/00; G01C 21/3691; G01C 21/3626; G01C 21/3461

(57) ABSTRACT

A system and method to provide a trailer-considerate route recommendation involve obtaining logged information from vehicles, the logged information from each of the vehicles corresponding with a location of the vehicle, a time, a type of the vehicle, and a type of trailer pulled by the vehicle. A method includes obtaining potential routes under consideration for an on-going navigation by a trailering vehicle towing a towed trailer and obtaining road characteristics for the potential routes. A risk score is computed for each of the potential routes, the risk score being a weighted sum of risk factors. Each of the risk factors results from quantifying the logged information or the road characteristics. The trailer-considerate route recommendation is provided based on the risk score associated with each of the potential routes to affect the on-going navigation by the trailering vehicle.

### INTRODUCTION

The subject disclosure relates to trailer-considerate route recommendations.

Vehicles (e.g., automobiles, trucks, farm equipment, construction equipment) are increasingly equipped with navigation systems that provide turn-by-turn directions to an operator-specified destination from a given location of the vehicle. When more than one route is available, operator-specified preferences may influence the route that is ultimately provided. When a vehicle is pulling a trailer, the route that may otherwise be selected may not be the safest or most comfortable route. Accordingly, it is desirable to provide trailer-considerate route recommendations.

### SUMMARY

In one exemplary embodiment, a method of providing a trailer-considerate route recommendation includes obtaining logged information from vehicles. The logged information from each of the vehicles corresponds with a location of the vehicle, a time, a type of the vehicle, and a type of trailer pulled by the vehicle. The method includes obtaining potential routes under consideration for an on-going navigation by a trailering vehicle towing a towed trailer, obtaining road characteristics for the potential routes, and computing a risk score for each of the potential routes, the risk score being a weighted sum of risk factors. Each of the risk factors results from quantifying the logged information or the road characteristics. The trailer-considerate route recommendation is provided based on the risk score associated with each of the potential routes to affect the on-going navigation by the trailering vehicle.

In addition to one or more of the features described herein, the method also includes empirically determining a weight corresponding with each risk factor used in the risk score.

In addition to one or more of the features described herein, the method also includes obtaining trailer-specific operator preferences and adjusting the weight corresponding each risk factor to which one of the trailer-specific operator preferences corresponds.

In addition to one or more of the features described herein, the method also includes using defaults for trailer-specific operator preferences that are not indicated by an operator.

In addition to one or more of the features described herein, the method also includes obtaining one or more of the trailer-specific operator preferences based on monitoring of driving behavior and machine learning.

In addition to one or more of the features described herein, the trailer-specific operator preferences include degree of tolerance for extra time or distance from a fastest or shortest route, degree of tolerance for danger of a route, degree of tolerance for route characteristics or degree of tolerance for ride comfort.

In addition to one or more of the features described herein, the method also includes categorizing the logged information according to the type of the vehicle and the type of the trailer.

In addition to one or more of the features described herein, the logged information used for the risk factors is specific to a category of the logged information matching a type of the trailering vehicle and a type of the towed trailer.

In addition to one or more of the features described herein, the obtaining the road characteristics for the potential routes is from a map database.

In addition to one or more of the features described herein, the providing the trailer-considerate route recommendation is to a central mapping system that communicates with the trailering vehicle or to an in-vehicle navigation system of the trailering vehicle.

In another exemplary embodiment, a system to provide a trailer-considerate route recommendation includes memory to store logged information provided by vehicles. The logged information from each of the vehicles corresponds with a location of the vehicle, a time, a type of the vehicle, and a type of trailer pulled by the vehicle. The system also includes a processor to obtain potential routes under consideration for an on-going navigation by a trailering vehicle towing a towed trailer, to obtain road characteristics for the potential routes, and to compute a risk score for each of the potential routes, the risk score being a weighted sum of risk factors. Each of the risk factors results from quantifying the logged information or the road characteristics. The processor provides the trailer-considerate route recommendation based on the risk score associated with each of the potential routes to affect the on-going navigation by the trailering vehicle.

In addition to one or more of the features described herein, the processor empirically determines a weight corresponding with each risk factor used in the risk score.

In addition to one or more of the features described herein, the processor obtains trailer-specific operator preferences and to adjust the weight corresponding each risk factor to which one of the trailer-specific operator preferences corresponds.

In addition to one or more of the features described herein, the processor uses defaults for trailer-specific operator preferences that are not indicated by an operator.

In addition to one or more of the features described herein, the processor obtains one or more of the trailer-specific operator preferences based on monitoring of driving behavior and machine learning.

In addition to one or more of the features described herein, the trailer-specific operator preferences include degree of tolerance for extra time or distance from a fastest or shortest route, degree of tolerance for danger of a route, degree of tolerance for route characteristics or degree of tolerance for ride comfort.

In addition to one or more of the features described herein, the processor categorizes the logged information according to the type of the vehicle and the type of the trailer.

In addition to one or more of the features described herein, the logged information used for the risk factors is specific to a category of the logged information matching a type of the trailering vehicle and a type of the towed trailer.

In addition to one or more of the features described herein, the processor obtains the road characteristics for the potential routes from a map database.

In addition to one or more of the features described herein, the processor provides the trailer-considerate route recommendation to a central mapping system that communicates with the trailering vehicle or to an in-vehicle navigation system of the trailering vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of systems involved in generating and using trailer-considerate route recommendations according to one or more embodiments; and

FIG. 2 is a functional flow diagram illustrating the information flow involved in the generation of trailer-considerate route recommendations according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a navigation system in a vehicle provides a route, in the form of turn-by-turn directions, to reach an operator-specified destination from a current location of the vehicle. When the vehicle is towing a trailer, turns, lane widths, elevation changes, and other route attributes that are not problematic for a vehicle without a trailer may be less safe or comfortable when the trailer is being towed. Embodiments of the systems and methods detailed herein relate to trailer-considerate route recommendations. Specifically, in addition to operator-specified preferences (e.g., choose fastest route, avoid tolls), recommendations that consider the trailer and the vehicle towing the trailer are also provided to the navigation system to be used in the route selection. The trailer-considerate route recommendations may consider historical data provided by other vehicles, road information, and/or operator preferences that are specific to towing a trailer.

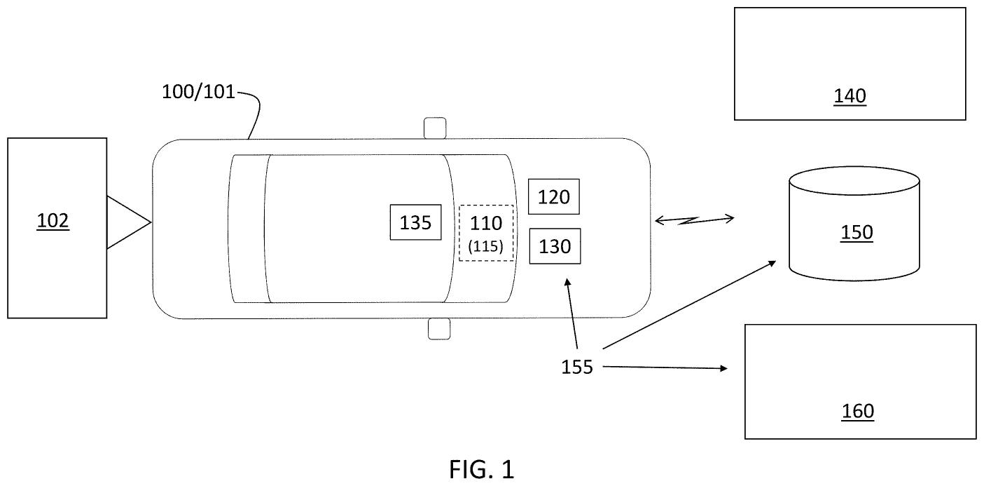

In accordance with an exemplary embodiment, FIG. 1 is a block diagram of systems involved in generating and using trailer-considerate route recommendations. An exemplary vehicle 100 shown in FIG. 1 is an automobile 101. As shown, the vehicle 100 tows a trailer 102. The vehicle 100 includes an infotainment system 110 with an interface 115 (e.g., display, touchscreen). The interface 115 facilitates operator inputs (e.g., destination, preferences) and output such as, for example, the display of a map indicating turn-by-turn directions. The vehicle 100 also includes a controller 120 that may control different aspects of operation of the vehicle 100 and may, for example, facilitate semi-autonomous operation (e.g., adaptive cruise control, automatic braking). The controller 120 may additionally communicate with sensors 135 (e.g., inertial measurement unit (IMU), wheel-speed sensor, steering sensor, cameras, radar system) that obtain information about the vehicle 100 and its surroundings.

The vehicle 100 additionally includes an in-vehicle navigation system 130. The in-vehicle navigation system 130 functionality may be performed by the controller 120. The controller 120 and, if separate, the in-vehicle navigation system 130 include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. This in-vehicle navigation system 130 may include a global navigation satellite system (GNSS) such as a global positioning system (GPS) to ascertain the location of the vehicle 100. The in-vehicle navigation system 130 obtains operator preferences for navigation (e.g., avoid toll roads, select fastest route) and provides turn-by-turn directions via the interface 115.

The in-vehicle navigation system 130 communicates with a central mapping system 160 and/or a map database 150. The in-vehicle navigation system 130, map database 150, and central mapping system 160 may be considered together as the navigation system 155. Thus, while the in-vehicle navigation system 130, map database 150, and central mapping system 160 functionalities are discussed individually for explanatory purposes, that functionality may be performed by any one or more of the components of the navigation system 155. The map database 150 stores information about roadways. The information includes road characteristics such as lane width, road class, road curvature, road grade, and the like. The map database 150 may be part of the central mapping system 160 or may be stored separately, as shown.

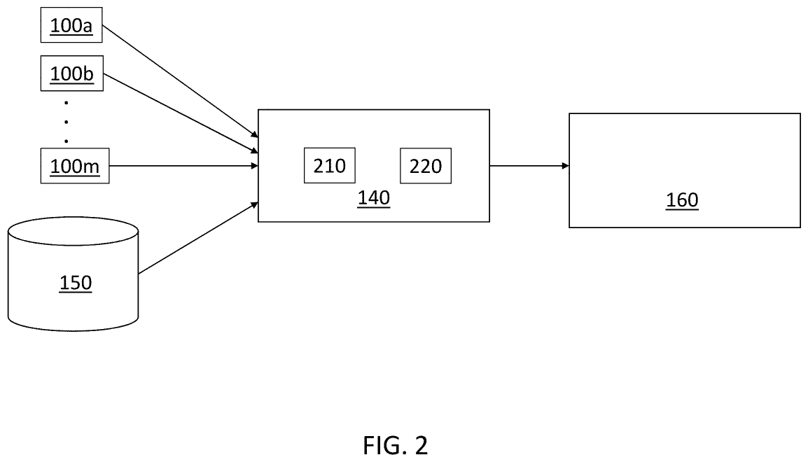

The central mapping system 160 communicates with the in-vehicle navigation systems 130 of a number of vehicles 100. For a given vehicle 100, the central mapping system 160 obtains the current location and operator-selected destination (i.e., destination entered via interface 115), as well as any operator preferences from the in-vehicle navigation system 130. The central mapping system 160 may also communicate with one or more servers that provide real-time traffic information. The central mapping system includes or communicates with the map database 150 that provides information about road characteristics. According to one or more embodiments, the central mapping system 160 additionally communicates with a central processing system 140 that provides the trailer-considerate route recommendations, as further detailed with reference to FIG. 2. Based on all the communication, the central mapping system 160 provides the turn-by-turn directions that the in-vehicle navigation system 130 displays via the interface 115. According to alternate embodiments, the central mapping system 160 provides information that the in-vehicle navigation system 130 uses to display turn-by-turn directions via the interface 115.

The central processing system 140 communicates with a number of vehicles 100 in addition to the map database 150 and central mapping system 160. The central processing system 140 provides a trailer-considerate route recommendation to the central mapping system 160. Functionality of the central processing system 140 is detailed with reference to FIG. 2. The information exchange and communication noted among the various components shown in FIG. 1 may be wireless, for example.

FIG. 2 is a functional flow diagram illustrating the information flow involved in the generation of trailer-considerate route recommendations according to one or more embodiments. As previously noted for the controller 120 and in-vehicle navigation system 130, the central processing system 140 also includes processing circuitry that may include memory 210 and one or more processors 220. The memory 210 may store information obtained by the central processing system 140 from one or more vehicles 100a through 100m (generally referred to as 100) and the map database 150. The one or more processors 220 of the central processing system 140 use the information from the vehicles 100 and the map database 150 to provide trailer-considerate route recommendations to the central mapping system 160. Although the flow of communication into and out of the central processing system 140 is indicated in FIG. 2, the other components communicate with each other, as well, as discussed with reference to FIG. 1.

As indicated, at any given time, the central processing system 140 obtains information from any number of vehicles 100. One or more of those vehicles 100 may additionally perform a navigation function. For explanatory purposes, vehicle 100a is assumed to perform a navigation function. That is, a destination is entered via interface 115 in vehicle 100a. Thus, in addition to the type of information that is provided by all the vehicles 100, which is further detailed, potential routes are also provided by the vehicle 100a as the vehicle 100a travels toward the destination. The potential routes provided by the vehicle 100a to the central processing system 140 may originate at the central mapping system 160, which provides the potential upcoming routes to the in-vehicle navigation system 130 of the vehicle 100a, for example.

The information provided by the vehicles 100 communicating with the central processing system 140 is based on direct measurements by one or more sensors 135 or is data inferred from measurements by one or more sensors 135. The information provided by the vehicles 100 may come from the controller 120, in-vehicle navigation system 130, or a combination of the two in each of the vehicles 100. The information may be provided continuously (e.g., periodically) or based on the occurrence of a predefined condition for logged data, as further discussed. Data logged in each vehicle 100 includes static data, such as data that indicates a size of the vehicle 100 (e.g., small-mass car, large-mass truck), whether a trailer 102 is connected and, if so, data indicating a type of the trailer 102 (e.g., dimensions, weight, number of tires). Data logged in each vehicle 100 also includes dynamic data, such as transmission gear or trailer brake request. This dynamic data may be logged in the vehicle 100 along with a corresponding location provided by the in-vehicle navigation system 130 and time. Exemplary dynamic logged data is shown in Table 1.

TABLE 1
Exemplary logged data in a given vehicle 100.
logged data

engine displacement and torque
engine/axle torque levels
transmission gear selection (e.g., low gear indicates a challenge to driving
with a trailer)
trailer brake request (e.g., a high number over a given duration indicates a
challenge to driving with a trailer)
trailer stability assist (e.g., a high number of activations of this system
indicates a challenge to driving with a trailer)
trailer tire temperature
trailer brake status
steering profile
wind direction and speed
lateral acceleration
road departure (e.g. a high number of road departures by different vehicles
100 at the same location indicates a challenge to driving with a trailer)
anomaly - as indicated by driver response (e.g., a high frequency indicates
a challenge to driving with a trailer and may be correlated with a time of
day or temperature)

As noted, the logged data may be provided as information from each vehicle 100 to the central processing system 140. According to alternate embodiments, logged data may be tested for a condition that, when met, triggers sending all or a subset of the logged data as information from a given vehicle 100 to the central processing system 140, along with corresponding the location and time. For example, the wind speed exceeding a threshold wind speed value may be a predefined condition. This information may indicate a route (corresponding with the location at the time the wind speed was logged) with high winds that may be unsuitable to a trailer 102. The trailer brake request being issued more than a threshold number of times over a predefined duration may be another exemplary condition. This information may indicate a steep downgrade that may also be unsuitable for a trailer 102.

In addition to the information from vehicles 100, the central processing system 140 also obtains information about road characteristics corresponding with the information from the vehicles 100 from the map database 150. This is further discussed with reference to Table 2. The central processing system 140 may categorize information that it receives from the vehicles 100 according to the type (e.g., mass, size) of the vehicles 100 and the size, weight, and type of the trailers 102. This type of categorization may facilitate the central processing system 140 providing trailer-considerate routing preferences that are more specific to the type of vehicle 100 (e.g., vehicle 100a) and the trailer 102 that the vehicle 100a is towing. Within each category of vehicle 100 and trailer 102 combination, the central processing system 140 may compute a risk score for roadways for which it has information from the vehicles 100 and map database 150, as detailed.

When the central processing system 140 obtains potential routes from the vehicle 100a performing navigation, the central processing system 140 computes a risk score associated with each of the potential routes based on the logged data from other vehicles 100 that travelled along those routes, on route characteristics obtained from the map database 150, or both. The logged data used for the risk score may be limited to categorized logged data that corresponds with the type of the vehicle 100a and the trailer 102 that it is towing. The risk score is given by:

risk score=Σᵢ₌₁ⁿwᵢxᵢ [EQ. 1]

In EQ. 1, a set of n risk factors (xᵢ) are considered, and the risk score is a sum of the product of a weighting associated with each risk factor (wᵢ) and the risk factor (xᵢ).

Each risk factor for a given potential route is a type of data listed in Table 1 or a road condition of the given potential route that is obtained from the map database 150. Exemplary road conditions that correspond with risk factors are listed in Table 2.

TABLE 2
Exemplary road conditions.

mix of road types (e.g., highway and local; divided and undivided;
construction, paved, winding)
maneuvers (e.g., left, right, and U-turns; number of lanes to cross)
traffic volume (e.g., rural road; dense urban area)
additional features (e.g., guardrails, tunnels, bridges, overhead
structures, toll roads, roadside barriers, lane width, shoulder type
and width, includes trailer-friendly rest areas)
road condition (e.g., grade, surface type, condition, superelevation)

According to exemplary embodiments, in addition to operator preferences for navigation, operator preferences for navigation when towing a trailer (i.e., trailer-specific preferences) may also be provided by the operator via the interface 115. The trailer-specific operator preferences may be in the form of a degree of tolerance. For example, trailer-specific operator preferences may specify the degree of tolerance for extra time or distance from the fastest or shortest route, for the safety of a route (i.e., what degree of danger the operator is willing to tolerate), for route characteristics (e.g., slope, narrowness, minimum turn radius, trailer height clearance), and for ride comfort (e.g., road roughness, curvature, trailer sway or gravitational force equivalent (g-force)). Default choices may be used for any items that are not specifically edited by an operator via the interface 115.

As previously discussed, the operator may specify navigation preferences. These operator preferences for navigation may be provided to the central mapping system 160 when the central mapping system 160 ultimately determines the turn-by-turn directions rather than the in-vehicle navigation system 130. Trailer-specific operator preferences, unlike navigation preferences, are provided to the central processing system 140. At the central processing system 140, the trailer-specific operator preferences may adjust the weighting of risk factors used in the risk score according to EQ. 1. Which weight is affected by which trailer-specific operator preferences and by how much may be specified by a mapping since each of the trailer-specific operator preferences is a known parameter and has a default value.

Machine learning or a look-up table approach may be used to quantify each risk factor. The weighting associated with each risk factor may be determined empirically, for example, and then adjusted by a trailer-specific operator preference. Machine learning may also be used to adjust default values for trailer-specific operator preferences that an operator has not explicitly specified via the interface 115. That is, driving behavior may be monitored and used to adjust default values for trailer-specific operator preferences that are provided to the central processing system 140. Exemplary monitored behaviors include the number of lane changes, speed (i.e., under or over the speed limit) on straight roads, braking on downslopes, braking on curves, and typical stops when towing a trailer.

By obtaining a risk score, according to EQ. 1, for each of the potential routes indicated by the in-vehicle navigation system 130 of the vehicle 100a, the central processing system 140 may determine a trailer-considerate route preference. The trailer-considerate route preference may be represented and presented differently according to alternate embodiments. For example, the risk score computed for each of the potential routes may be converted or normalized to present a route score to the central mapping system 160. This conversion may be based on a mapping of a range of risk score values to a route score, for example.

A weighting may be indicated along with the route score. For example, if there are two potential routes, and one of those routes includes an overpass that the trailer 102 is too tall to fit under, then the weighting associated with the route score of the other route may be 100. Alternately, each route score may be associated with an indication of “optional” or “must-take” (if it is the only viable route among the potential routes) or “must not take” (if it is the only non-viable route among the potential routes). According to alternate embodiments, the trailer-considerate route recommendation may be provided in the form of a ranking of the potential routes rather than a route score. The ranking may be accompanied with a weighting or indication, as discussed. Based on the trailer-considerate route recommendation from the central processing system 140, the central mapping system 160, which need not be aware of the trailer 102 at all, can provide turn-by-turn directions to the in-vehicle navigation system 130 for display via the interface 115 of the vehicle 100a.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of providing a trailer-considerate route recommendation, the method comprising:
obtaining, by a processing system, logged information from vehicles, the logged information from each of the vehicles corresponding with a location of the vehicle, a time, a type of the vehicle, and a type of trailer pulled by the vehicle;
obtaining, by the processing system, potential routes under consideration for an on-going navigation by a trailering vehicle towing a towed trailer;
obtaining, by the processing system, road characteristics for the potential routes;
computing, by the processing system, a risk score for each of the potential routes, the risk score being a weighted sum of risk factors, wherein each of the risk factors results from quantifying the logged information or the road characteristics; and
providing, from the processing system, the trailer-considerate route recommendation based on the risk score associated with each of the potential routes to affect the on-going navigation by the trailering vehicle.

2. The method according to claim 1, further comprising empirically determining a weight corresponding with each risk factor used in the risk score.

3. The method according to claim 2, further comprising obtaining trailer-specific operator preferences and adjusting the weight corresponding each risk factor to which one of the trailer-specific operator preferences corresponds.

4. The method according to claim 3, further comprising using defaults for trailer-specific operator preferences that are not indicated by an operator.

5. The method according to claim 3, further comprising obtaining one or more of the trailer-specific operator preferences based on monitoring of driving behavior and machine learning.

6. The method according to claim 3, wherein the trailer-specific operator preferences include degree of tolerance for extra time or distance from a fastest or shortest route, degree of tolerance for danger of a route, degree of tolerance for route characteristics or degree of tolerance for ride comfort.

7. The method according to claim 1, further comprising categorizing the logged information according to the type of the vehicle and the type of the trailer.

8. The method according to claim 7, wherein the logged information used for the risk factors is specific to a category of the logged information matching a type of the trailering vehicle and a type of the towed trailer.

9. The method according to claim 1, wherein the obtaining the road characteristics for the potential routes is from a map database.

10. The method according to claim 1, wherein the providing the trailer-considerate route recommendation is to a central mapping system that communicates with the trailering vehicle or to an in-vehicle navigation system of the trailering vehicle.

11. A system to provide a trailer-considerate route recommendation, the system comprising:
memory configured to store logged information provided by vehicles, the logged information from each of the vehicles corresponding with a location of the vehicle, a time, a type of the vehicle, and a type of trailer pulled by the vehicle; and
a processor configured to obtain potential routes under consideration for an on-going navigation by a trailering vehicle towing a towed trailer, to obtain road characteristics for the potential routes, to compute a risk score for each of the potential routes, the risk score being a weighted sum of risk factors, wherein each of the risk factors results from quantifying the logged information or the road characteristics, and to provide the trailer-considerate route recommendation based on the risk score associated with each of the potential routes to affect the on-going navigation by the trailering vehicle.

12. The system according to claim 11, wherein the processor is further configured to empirically determine a weight corresponding with each risk factor used in the risk score.

13. The system according to claim 12, wherein the processor is further configured to obtain trailer-specific operator preferences and to adjust the weight corresponding each risk factor to which one of the trailer-specific operator preferences corresponds.

14. The system according to claim 13, wherein the processor is further configured to use defaults for trailer-specific operator preferences that are not indicated by an operator.

15. The system according to claim 13, wherein the processor is further configured to obtain one or more of the trailer-specific operator preferences based on monitoring of driving behavior and machine learning.

16. The system according to claim 13, wherein the trailer-specific operator preferences include degree of tolerance for extra time or distance from a fastest or shortest route, degree of tolerance for danger of a route, degree of tolerance for route characteristics or degree of tolerance for ride comfort.

17. The system according to claim 11, wherein the processor is further configured to categorize the logged information according to the type of the vehicle and the type of the trailer.

18. The system according to claim 17, wherein the logged information used for the risk factors is specific to a category of the logged information matching a type of the trailering vehicle and a type of the towed trailer.

19. The system according to claim 11, wherein the processor is configured to obtain the road characteristics for the potential routes from a map database.

20. The system according to claim 11, wherein the processor is configured to provide the trailer-considerate route recommendation to a central mapping system that communicates with the trailering vehicle or to an in-vehicle navigation system of the trailering vehicle.
